(19) United States
(12) Patent Application Publication
(10) Pub. No.: US 2026/0081521 A1
(43) Pub. Date: Mar. 19, 2026

(54) SEMICONDUCTOR DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Chen Kong TEH, Tokyo (JP)

(73) Assignees: KABUSHIKI KAISHA TOSHIBA, Tokyo (JP); TOSHIBA ELECTRONIC DEVICES & STORAGE CORPORATION, Tokyo (JP)

(21) Appl. No.: 19/049,047

(22) Filed: Feb. 10, 2025

(30) Foreign Application Priority Data
Sep. 13, 2024 (JP) 2024-159185

(51) Int. Cl. H02M 3/07

(52) U.S. Cl. CPC H02M 3/07

(57) ABSTRACT

According to one embodiment, a semiconductor device includes: a first switch element having a first end, and a second end and a gate which are mutually coupled in common; a second switch element having a first end, a gate coupled to the gate of the first switch element; a level shifter having input ends to which a first voltage, a voltage of the first end of the second switch element, and a first signal are input, a first output end, and a second output end; a third switch element having a first end coupled to a first node, and a gate controlled by a signal output to the second output end; and a fourth switch element having a first end controlled by a signal output to the first node, a gate coupled to the second output end, and a second end to which the first voltage is input.

### CROSS-REFERENCE TO RELATED APPLICATIONS

This application is based upon and claims the benefit of priority from Japanese Patent Application No. 2024-159185, filed Sep. 13, 2024, the entire contents of which are incorporated herein by reference.

### FIELD

Embodiments described herein relate generally to a semiconductor device.

### BACKGROUND

A semiconductor device for supplying a voltage to a load has been known. Such a semiconductor device includes a charge pump for boosting a voltage.

### BRIEF DESCRIPTION OF THE DRAWINGS

FIG. 1 is a block diagram showing an example of a configuration of a semiconductor device according to an embodiment.

FIG. 2 is a circuit diagram for illustrating an example of the configuration of the semiconductor device according to the embodiment.

FIG. 3 is a timing chart for illustrating an operation of the semiconductor device according to the embodiment.

FIG. 4 is a circuit diagram showing a part of the semiconductor device, for illustrating an operation of the semiconductor device according to the embodiment.

FIG. 5 is a circuit diagram showing a part of the semiconductor device, for illustrating an operation of the semiconductor device according to the embodiment.

### DETAILED DESCRIPTION

In general, according to one embodiment, a semiconductor device includes: a first resistor having a first end to which a first voltage is input, and a second end; a first switch element having a first end coupled to the second end of the first resistor, and a second end and a gate which are mutually coupled in common; a second switch element having a first end to which a second voltage lower than the first voltage is input, a gate coupled to the second end and the gate of the first switch element, and a grounded second end; a level shifter having a first input end to which the first voltage is input, a second input end coupled to the first end of the second switch, a third input end to which a first signal is input, a first output end, and a second output end; a first capacitor having a first end coupled to the first output end of the level shifter, and a second end coupled to a first node; a third switch element having a first end coupled to the first node, and a gate configured to be controlled in accordance with a signal output to the second output end of the level shifter; and a fourth switch element having a first end configured to be controlled in accordance with a signal output to the first node, a gate coupled to the gate of the third switch element and to the second output end of the level shifter, and a second end to which the first voltage is input, wherein the level shifter is configured to output, based on the first voltage, the second voltage, and the first signal, a second signal which is level-shifted to a voltage higher than a voltage of the first signal from the first output end and a third signal which is an inversion signal of the second signal from the second output end.

Hereinafter, embodiments will be described with reference the accompanying drawings. In the following explanation, components having the same functions and configurations will be referred to by the same reference symbols.

### 1. Embodiment

A semiconductor device according to an embodiment will be described.

First, a configuration of the semiconductor device according to the embodiment will be described.

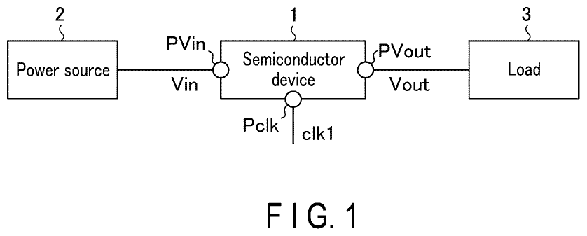

The configuration of the semiconductor device according to the embodiment will be described with reference to FIG. 1. FIG. 1 is a block diagram showing an example of the configuration of the semiconductor device according to the embodiment.

A semiconductor device 1 is, for example, an integrated circuit (IC) chip. The semiconductor device 1 generates a voltage Vout based on a voltage Vin supplied from a power source 2 external to the semiconductor device 1 and a signal clk1, for example. The voltage Vout is a voltage higher than the voltage Vin (Vout>Vin). The signal clk1 is a clock signal. A voltage at an “L (Low)” level of the signal clk1 is, for example, a voltage VSS. The voltage VSS is a ground voltage. A voltage at an “H (High)” level of the signal clk1 is, for example, a voltage VDD. The voltage VDD is a voltage higher than the voltage VSS (VDD>VSS). As described above, the semiconductor device 1 is configured to boost the voltage Vin using a clock signal. The semiconductor device 1 outputs the voltage Vout to a load 3.

The semiconductor device 1 includes terminals Pvin, Pclk, and PVout.

The terminal PVin is coupled to, for example, the power source 2 external to the semiconductor device 1. The voltage Vin is supplied to the terminal PVin from the power source 2.

The signal clk1 is supplied to the terminal Pclk from, for example, a circuit external to the semiconductor device 1. The embodiment describes an example in which the signal clk1 is input from an outside of the semiconductor device 1; however, this example is not a limitation. The signal clk1 may be generated by an internal configuration of the semiconductor device 1.

The terminal PVout is coupled to the load 3. A voltage VOUT is supplied from the terminal PVout to the load 3.

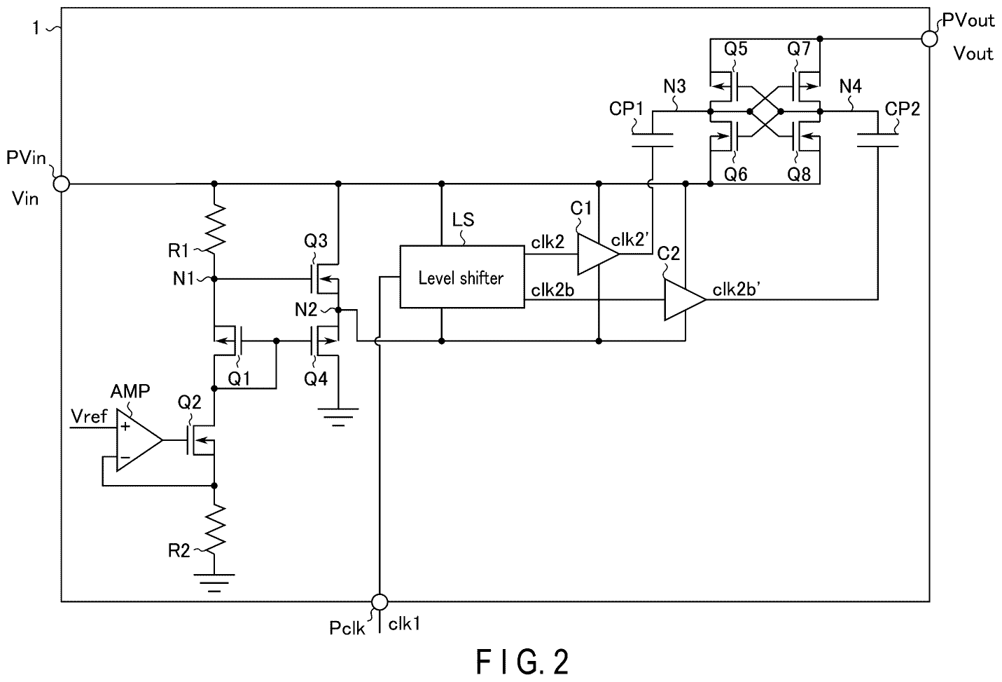

Next, a circuit configuration of the semiconductor device 1 will be described with reference to FIG. 2. FIG. 2 is a circuit diagram for illustrating an example of the configuration of the semiconductor device according to the embodiment.

The semiconductor device 1 includes switch elements Q1, Q2, Q3, Q4, Q5, Q6, Q7, and Q8, resistors R1 and R2, an operational amplifier AMP, a level shifter LS, capacitors CP1 and CP2, and circuits C1 and C2.

The switch elements Q2, Q3, Q6, and Q8 are, for example, N-type metal-oxide-semiconductor field effect transistors (MOSFETs). The switch element Q2 is, for example, an N-type MOSFET having a higher breakdown voltage than those of the switch elements Q3, Q6, and Q8. The switch elements Q1, Q4, Q5, and Q7 are, for example, P-type MOSFETs. The switch elements Q1 and Q4 are, for example, P-type MOSFETs each having a higher breakdown voltage than those of the switch elements Q5 and Q7.

One end of the resistor R1 is coupled to the terminal PVin. The other end of the resistor R1 is coupled to a node N1. The resistor R1 is a resistor in which a resistance value changes depending on the temperature. The resistor R1 is configured such that, for example, a resistance value decreases as the temperature increases. The resistor R1 is, for example, a poly resistor (polysilicon resistor).

Meanwhile, the resistor R1 is configured such that a voltage of the node N1 is equivalent to the voltage (Vin−VDD).

One end of the switch element Q1 is coupled to the node N1. The gate and the other end of the switch element Q1 are mutually coupled in common.

One end of the switch element Q2 is coupled to the gate and the other end of the switch element Q1.

The operational amplifier AMP includes a non-inversion input terminal (+), an inversion input terminal (−), and an output terminal. A voltage Vref that does not depend on the temperature is supplied to the non-inversion input terminal (+) of the operational amplifier AMP. The voltage Vref is, for example, a voltage lower than the voltage (Vref<(Vin−VDD)). The inversion input terminal (−) of the operational amplifier AMP is coupled to the other end of the switch element Q2. The output terminal of the operational amplifier AMP is coupled to the gate of the switch element Q2. The operational amplifier AMP makes a magnitude comparison between the voltage Vref of the non-inversion input terminal (+) and a voltage of the inversion input terminal (−) (a voltage of the other end of the switch element Q2). In the case of a voltage of the other end of the switch element Q2 being higher than the voltage Vref, a low voltage is output from the output terminal of the operational amplifier AMP. If the voltage of the other end of the switch element Q2 is equal to or lower than the voltage Vref, a high voltage is output from the output terminal of the operational amplifier AMP. Through the operation described above, the operational amplifier AMP is configured such that a voltage of the other end of the switch element Q2 is equivalent to the voltage Vref that does not depend on the temperature.

One end of the resistor R2 is coupled to the other end of the switch element Q2 and to the inversion input terminal (−) of the operational amplifier AMP. The other end of the resistor R2 is grounded. The resistor R2 is a resistor in which a resistance value changes depending on the temperature, as with the resistor R1. The resistor R2 is configured such that, for example, a resistance value decreases as the temperature increases, as with the resistor R1. The resistor R2 is, for example, a poly resistor (polysilicon resistor), as with the resistor R1. A voltage applied to the resistor R2 is the voltage Vref that does not depend on the temperature, so that a current applied to the resistor R2 becomes greater as the temperature increases. Such a voltage is also applied to the resistor R1, so that a voltage applied to the resistor R1 becomes independent of the temperature. This realizes a configuration in which the voltage of the node N1 becomes the voltage (Vin−VDD) without depending on the temperature.

In the configuration described above, a part including the switch element Q2, the operational amplifier AMP, and the resistor R2 functions as a current source.

One end of the switch element Q3 is coupled to the terminal PVin. The other end of the switch element Q3 is coupled to the node N2. The gate of the switch element Q3 is coupled to the node N1.

One end of the switch element Q4 is coupled to the node N2. The other end of the switch element Q4 is grounded. The gate of the switch element Q4 is coupled to the gate of the switch element Q1 and the other end of the switch element Q1 in common.

In the configuration described above, a part including the switch elements Q1 and Q4 is configured such that the voltage VN1 of the node N1 and the voltage VN2 of the node N2 are equivalent to each other. That is, the voltages VN1 and VN2 are equivalent to the voltage (Vin−VDD).

In the configuration described above, the switch element Q3 functions as a pull-up circuit of the node N2. Furthermore, the switch element Q4 functions as a pull-down circuit of the node N2.

As an additional note, for example, in a case where the voltage VN2 becomes lower than the voltage VN1 (voltage (Vin−VDD)), the switch element Q3 operates as a pull-up circuit. Accordingly, the voltage VN2 becomes a voltage equivalent to the voltage VN1 (voltage (Vin−VDD)). Furthermore, for example, in a case where the voltage VN2 becomes higher than the voltage VN1 (voltage (Vin−VDD)), the switch element Q4 operates as a pull-down circuit. Accordingly, the voltage VN2 becomes a voltage equivalent to the voltage VN1 (voltage (Vin−VDD)).

Furthermore, a part including the switch elements Q1, Q3, and Q4 functions as a buffer current configured to drive a large current. This enables a current flowing into the switch element Q3 and a current flowing into the switch element Q4 to be larger than, for example, a current flowing into the resistor R1 and a current flowing into the switch element Q2, so that the node N2 becomes a voltage source (voltage (Vin−VDD)) having a low impedance.

The level shifter LS includes a first input end, a second input end, a third input end, a first output end, and a second output end. The first input end of the level shifter LS is coupled to the terminal PVin. In this manner, the voltage Vin is input to the level shifter LS. The second input end of the level shifter LS is coupled to the node N2. In this manner, the voltage VN2 equivalent to the voltage (Vin−VDD) is input to the level shifter LS. The signal clk1 is input to the third input end of the level shifter LS. The level shifter LS generates signals clk2 and clk2b using the voltages Vin and VN2 input as described above and the signal clk1. Each of the signals clk2 and clk2b is a clock signal. The signal clk2b is an inversion signal of the signal clk2. The generation of the signals clk2 and clk2b will be described later. The signal clk2 is output from the first output end of the level shifter LS. The signal clk2b is output from the second output end of the level shifter LS.

Regarding the generation of the signals clk2 and clk2b, more specifically, the level shifter LS generates the signals clk2 and clk2b such that a voltage at an “H” level (high voltage) of the signals clk2 and clk2b is equivalent to the voltage Vin. The level shifter LS generates the signals clk2 and clk2b such that a voltage at an “L” level of the signals clk2 and clk2b is equivalent to the voltage (Vin−VDD).

The circuit C1 includes a first input end, a second input end, a third input end, and an output end. The first input end of the circuit C1 is coupled to the first output end of the level shifter LS. The second input end of the circuit C1 is coupled to the terminal PVin. The third input end of the circuit C1 is coupled to the node N2. The circuit C1 generates a signal clk2′ based on the signal clk2. The signal clk2′ is a clock signal that is generated such that a voltage at the “H” level is equal to the voltage Vin and a voltage at the “L” level is equal to the voltage (Vin−VDD), as with the signal clk2. The signal clk2′ is output from the output end of the circuit C1. The circuit C1 has a configuration in which, for example, two inverter circuits are coupled in series. With the configuration described above, the circuit C1 is provided to supply sufficient current to drive a charge pump, which will be described later, at the time of supplying a clock signal generated by the level shifter LS to the charge pump, for example.

The circuit C2 includes a first input end, a second input end, a third input end, and an output end. The first input end of the circuit C2 is coupled to the second output end of the level shifter LS. The second input end of the circuit C2 is coupled to the terminal PVin. The third input end of the circuit C2 is coupled to the node N2. The circuit C2 generates a signal clk2b′ based on the signal clk2b. The signal clk2b′ is a clock signal that is generated such that a voltage at the “H” level is equal to the voltage Vin and a voltage at the “L” level is equal to the voltage (Vin−VDD), as with the signal clk2b. The signal clk2b′ is an inversion signal of the signal clk2b. The signal clk2b′ is output from the output end of the circuit C2. The circuit C2 has a configuration in which, for example, two inverter circuits are coupled in series, as with the circuit C1. With the configuration described above, the circuit C2 is provided to supply sufficient current to drive a charge pump at the time of supplying a clock signal generated by the level shifter LS to the charge pump, for example, as with the circuit C1.

An end of the capacitor CP1 is coupled to the output end of the circuit C1. The other end of the capacitor CP1 is coupled to a node N3. The configuration described above enables a signal based on the signal clk2′ to be supplied to the node N3 via the capacitor CP1.

One end of the capacitor CP2 is coupled to the output end of the circuit C2. The other end of the capacitor CP2 is coupled to a node N4. The configuration described above enables a signal based on the signal clk2b′ to be supplied to the node N4 via the capacitor CP2.

One end of the switch element Q5 is coupled to the node N3. The gate of the switch element Q5 is coupled to the node N4. The other end of the switch element Q5 is coupled to the terminal PVout. The switch element Q5 is configured to be in an ON state while the voltage Vin is applied to the node N4. Furthermore, the switch element Q5 is configured to be in an OFF state while the voltage (Vin+VDD) is applied to the node N4.

One end of the switch element Q6 is coupled to the node N3. The gate of the switch element Q6 is coupled to the node N4, together with the gate of the switch element Q5. The other end of the switch element Q6 is coupled to the terminal PVin. The switch element Q6 is configured to be in the ON state while the voltage (Vin+VDD) is applied to the node N4. The switch element Q6 is configured to be in the OFF state while the voltage Vin is applied to the node N4.

One end of the switch element Q7 is coupled to the node N4. The gate of the switch element Q7 is coupled to the node N3. The other end of the switch element Q7 is coupled to the terminal PVout, together with the other end of the switch element Q5. The switch element Q7 is configured to be in the ON state while the voltage Vin is applied to the node N3. Furthermore, the switch element Q7 is configured to be in the OFF state while the voltage (Vin+VDD) is applied to the node N3.

One end of the switch element Q8 is coupled to the node N4. The gate of the switch element Q8 is coupled to the node N3, together with the gate of the switch element Q7. The other end of the switch element Q8 is coupled to the terminal PVin. The switch element Q8 is configured to be in the ON state while the voltage (Vin+VDD) is applied to the node N3. The switch element Q8 is configured to be in the OFF state while the voltage Vin is applied to the node N3.

The switch elements Q5 to Q8 and the capacitors CP1 and CP2 each function as a charge capacitor.

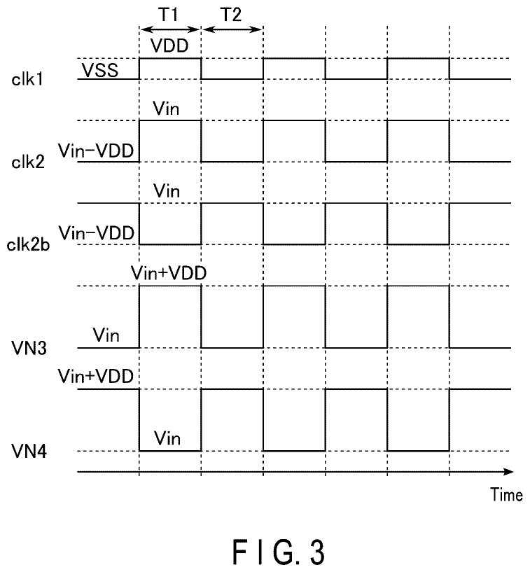

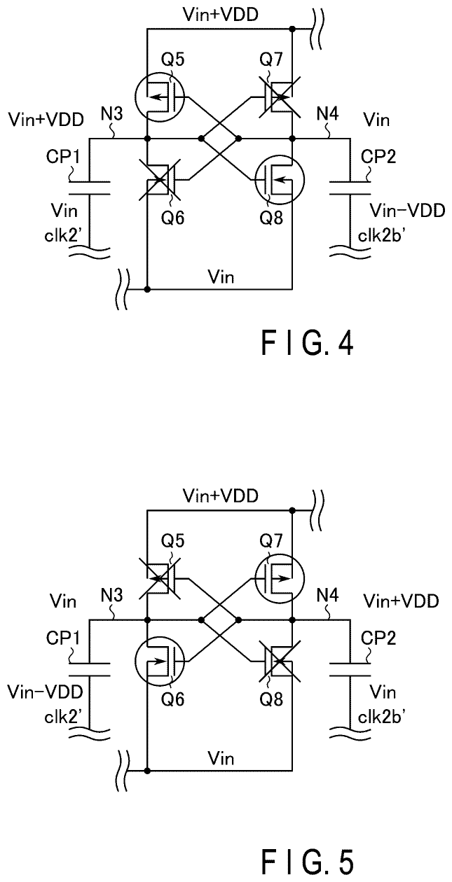

Next, an operation of the semiconductor device 1 according to the embodiment will be described with reference to FIG. 3, FIG. 4, and FIG. 5. FIG. 3 is a timing chart for illustrating an operation of the semiconductor device according to the embodiment. FIG. 3 shows the signals clk1, clk2, and clk2b in the operation of the semiconductor device 1, a voltage VN3 of the node N3, and a voltage VN4 of the node N4. FIG. 4 and FIG. 5 are each a circuit diagram showing a part of the semiconductor device, for illustrating an operation of the semiconductor device according to the embodiment.

At the time when the semiconductor device 1 operates, the signal clk1 is input as a clock signal to the semiconductor device 1, as described above. A time period T1 in which the signal clk1 is at the “H” level and a time period T2 in which the signal clk1 is at the “L” level have equivalent lengths.

In the semiconductor device 1 with the configuration described above, the signals clk2 and clk2b, which are signals inverted to each other, are generated based on the signal clk1 and the voltage Vin. The signal clk2 has the “H” level in the time period T1 and has the “L” level in the time period T2. The signal clk2b has the “L” level in the time period T1 and has the “H” level in the time period T2. Illustration of voltages of the signals clk2′ and clk2b′ based on the signals clk2 and clk2b is omitted since they change in a similar manner to those of the signals clk2 and clk2b.

Furthermore, while the signals clk2 and clk2′ are at the “H” level, and the signals clk2b and clk2b′ are at the “L” level, the voltage VN3 is set to the voltage (Vin+VDD) by the capacitor CP1 through an operation of the charge pump, which will be described later. On the other hand, the voltage VN4 is set to the voltage Vin.

Furthermore, while the signals clk2 and clk2′ are at the “L” level, and the signals clk2b and clk2b′ are at the “H” level, the voltage VN4 is set to the voltage (Vin+VDD) by the capacitor CP2 through an operation of the charge pump, which will be described later. On the other hand, the voltage VN3 is set to the voltage Vin.

An operation of the charge pump in the time period T1 will be described with reference to FIG. 4.

The voltage VN3 is set to the voltage (Vin+VDD) by the capacitor CP1 charged through an operation in the time period T2, which will be described later, and by the signal clk2′ set to the voltage Vin. This turns the switch element Q7 to the OFF state and the switch element Q8 to the ON state. Therefore, the voltage VN4 is set to be equivalent to the voltage Vin. Accordingly, the switch element Q5 is turned to the ON state and the switch element Q6 is turned to the OFF state. In the manner described above, in the time period T1, a voltage substantially equivalent to the voltage (Vin+VDD) is supplied to the terminal PVout via the switch element Q5 in the ON state.

The voltage Vin input via the terminal PVin charges the capacitor CP2 via the switch element Q8 in the ON state, based on the signal clk2b′ set to the voltage (Vin−VDD).

An operation of the charge pump in the time period T2 will be described with reference to FIG. 5.

The voltage VN4 is set to the voltage (Vin+VDD) by the capacitor CP2 charged through an operation in the time period T1, which will be described later, and by the signal clk2b′ set to the voltage Vin. This turns the switch element Q5 to the OFF state and the switch element Q6 to the ON state. Therefore, the voltage VN3 is set to be equivalent to the voltage Vin. Accordingly, the switch element Q7 is turned to the ON state and the switch element Q8 is turned to the OFF state. In the manner described above, in the time period T2, a voltage substantially equivalent to the voltage (Vin+VDD) is supplied to the terminal PVout via the switch element Q7 in the ON state.

The voltage Vin input via the terminal PVin charges the capacitor CP1 via the switch element Q6 in the ON state, based on the signal clk2′ set to the voltage (Vin−VDD).

As described above, in the operation of the semiconductor device 1, the voltage (Vin+VDD) is output from the terminal PVout to the load 3.

The semiconductor device 1 according to the embodiment includes a resistor R1, switch elements Q1, Q4, Q5, and Q6, the level shifter LS, and the capacitor CP1. The resistance R1 has a first end to which the voltage Vin is input. The switch element Q1 has a first end coupled to a second end of the resistor R1, and a second end and a gate which are mutually coupled in common. The switch element Q4 has a first end to which a voltage (Vin−VDD) is input, a gate coupled to the second end and the gate of the switch element Q1, and a grounded second end. The level shifter LS has a first input end to which the voltage Vin is input, a second input end coupled to the first end of the switch element Q4, a third input end to which the signal clk1 is input, a first output end, and a second output end. Based on the voltage Vin, the voltage (Vin−VDD), and the signal clk1, the level shifter LS outputs the signal clk2 level-shifted to a voltage higher than that of the signal clk1 from the first output end, and outputs the signal clk2b which is an inversion signal of the signal clk2b from the second output end. The capacitor CP1 has a first end coupled to the first output end of the level shifter LS and a second end coupled to the node N3. The switch element Q5 has a first end coupled to the node N3 and a gate coupled to the second output end of the level shifter LS. The switch element Q6 has a first end coupled to the node N3, a gate coupled to the gate of the switch element Q5 and to the second output end of the level shifter LS, and a second end to which the voltage Vin is input. The configuration described above can suppress an increase in manufacturing costs and an increase in chip size.

As an additional note, in a case where a voltage at the “L” level of a clock signal for charging a capacitor of a charging pump is a ground voltage, a potential difference between one end and the other end of the capacitor undesirably increases as compared to a case in which the aforementioned capacitor is charged using a clock signal whose voltage at the “L” level is higher than the ground voltage. By this, a capacitor having a higher breakdown voltage is formed in a semiconductor device according to a comparative example. This causes a problem wherein the formation of such a capacitor having a higher breakdown voltage increases costs and a chip size.

According to the embodiment, the signal clk2′ generated such that the “H” level is the voltage Vin and the “L” level is the voltage (Vin−VDD) higher than the voltage VSS is input to the other end of the capacitor CP1. This can suppress an increase in potential difference between one end and the other end of the capacitor CP1. Accordingly, an increase in cost and size of the capacitor can be suppressed.

### 2. Others

The above embodiment described the case in which the semiconductor device 1 includes a one-stage charge pump containing the switch elements Q5 to Q8; however, this case is not a limitation. The semiconductor device 1 may include a charge pump having a plurality of stages.

Although not shown, for example, in a case where the semiconductor device 1 includes a charge pump having two stages, the semiconductor device 1 further contains switch elements Q9, Q10, Q11, and Q12, and capacitors CP3 and CP4. The switch elements Q9, Q10, Q11, and Q12, and the capacitors CP3 and CP4 respectively have similar configurations to those of the switch element Q5 to Q8 and the capacitors CP1 and CP2.

One end of the capacitor CP3 is coupled to the output end of the circuit C1 as with the capacitor CP1, for example. The other end of the capacitor CP3 is coupled to the node N5.

One end of the capacitor CP4 is coupled to the output end of the circuit C2 as with the capacitor CP2, for example. The other end of the capacitor CP4 is coupled to the node N6.

One end of the switch element Q9 is coupled to the node N5. The gate of the switch element Q9 is coupled to the node N6. The other end of the switch element Q9 is coupled to the terminal PVout.

One end of the switch element Q10 is coupled to the node N5. The gate of the switch element Q10 is coupled to the node N6, together with the gate of the switch element Q9. The other end of the switch element Q10 is coupled to the other ends of the switch elements Q5 and Q7. In another example, the other ends of the switch elements Q5 and Q7 are coupled to the terminal PVout via the stage of the charge pump containing the switch elements Q9, Q10, Q11, and Q12.

One end of the switch element Q11 is coupled to the node N6. The gate of the switch element Q11 is coupled to the node N5. The other end of the switch element Q11 is coupled to the terminal PVout, together with the other end of the switch element Q9.

One end of the switch element Q12 is coupled to the node N6. The gate of the switch element Q12 is coupled to the node N5, together with the gate of the switch element Q11. The other end of the switch element Q12 is coupled to the other end of the switch element Q10 and to the other ends of the switch elements Q5 and Q7.

In the configuration described above, the switch elements Q5 to Q8 and the capacitors CP1 and CP2 each function as a first stage of the charge pump. Furthermore, the switch elements Q9 to Q12 and the capacitors CP3 and CP4 each function as a second stage of the charge pump.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor device comprising:
a first resistor having a first end to which a first voltage is input, and a second end;
a first switch element having a first end coupled to the second end of the first resistor, and a second end and a gate which are mutually coupled in common;
a second switch element having a first end to which a second voltage lower than the first voltage is input, a gate coupled to the second end and the gate of the first switch element, and a grounded second end;
a level shifter having a first input end to which the first voltage is input, a second input end coupled to the first end of the second switch, a third input end to which a first signal is input, a first output end, and a second output end;
a first capacitor having a first end coupled to the first output end of the level shifter, and a second end coupled to a first node;
a third switch element having a first end coupled to the first node, and a gate configured to be controlled in accordance with a signal output to the second output end of the level shifter; and
a fourth switch element having a first end configured to be controlled in accordance with a signal output to the first node, a gate coupled to the gate of the third switch element and to the second output end of the level shifter, and a second end to which the first voltage is input,
wherein the level shifter is configured to output, based on the first voltage, the second voltage, and the first signal, a second signal which is level-shifted to a voltage higher than a voltage of the first signal from the first output end and a third signal which is an inversion signal of the second signal from the second output end.

2. The semiconductor device according to claim 1, further comprising a first current source having a first end coupled to the second end and the gate of the first switch element, and a grounded second end.

3. The semiconductor device according to claim 2, wherein
the first current source comprises a fifth switch element having a first end coupled to the second end and the gate of the first switch element, and a second end,
an operational amplifier having a non-inversion input terminal to which a third voltage is input, an inversion input terminal coupled to the second end of the fifth switch, and an output terminal coupled to the gate of the fifth switch element, and
a second resistor having a first end coupled to the second end of the fifth switch element and to the inversion input terminal of the operational amplifier, and a grounded second end.

4. The semiconductor device according to claim 3, further comprising a sixth switch element having a first end coupled to the first end of the first resistor, a gate coupled to the second end of the first resistor and to the first end of the first switch element, and a second end coupled to the first end of the second switch element and to the second input end of the level shifter.

5. The semiconductor device according to claim 4, wherein
a current flowing into the sixth switch element is larger than a current flowing into the first resistor.

6. The semiconductor device according to claim 3, wherein the first resistor and the second resistor are each configured such that a resistance value decreases as a temperature increases.

7. The semiconductor device according to claim 1, further comprising:
a second capacitor having a first end coupled to the second output end of the level shifter, and a second end coupled to a second node;
a fifth switch element having a first end coupled to the second node, and a gate configured to be controlled in accordance with a signal output to the first node; and
a sixth switch element having a first end configured to be controlled in accordance with a signal output to the second node, a gate coupled to the gate of the fifth switch element and to the first node, and a second end coupled to the second end of the fourth switch element,
wherein the gate of the third switch element and the gate of the fourth switch element are coupled to the second node.

8. The semiconductor device according to claim 1, wherein
the first switch element, the fourth switch element, and the sixth switch element are each an N-type transistor, and
the second switch element, the third switch element, and the fifth switch element are each a P-type transistor.

9. The semiconductor device according to claim 1, wherein the first signal, the second signal, and the third signal are each a clock signal.

10. The semiconductor device according to claim 9, wherein for the second signal and the third signal, a high-voltage state is a state having the first voltage, and a low-voltage state is a state having the second voltage.

11. The semiconductor device according to claim 1, further comprising a first circuit having a first input end coupled to the first output end of the level shifter, a second input end to which the first voltage is input, a third input end coupled to the second input end of the level shifter and to the first end of the second switch element, and an output end coupled to the first end of the first capacitor, the first circuit being configured to supply a drive current to the first node via the first capacitor.

12. The semiconductor device according to claim 11, wherein the first circuit has two inverter circuits coupled in series.

13. The semiconductor device according to claim 3, wherein the third voltage is a voltage that does not depend on a temperature.

14. The semiconductor device according to claim 1, wherein the first voltage and the first signal are each a voltage supplied from an outside of the semiconductor device.
